(19) United States
(12) Patent Application Publication
(10) Pub. No.: US 2017/0070106 A1
(43) Pub. Date: Mar. 9, 2017

(54) NESTED DUAL MOTOR/GENERATOR

(71) Applicant: BorgWarner Inc., Auburn Hills, MI (US)

(72) Inventors: Chengyun GUO, Novi, MI (US); Joel MAGUIRE, Hartland, MI (US)

(21) Appl. No.: 15/249,601

(22) Filed: Aug. 29, 2016

Related U.S. Application Data
(60) Provisional application No. 62/215,290, filed on Sep. 8, 2015.

(51) Int. Cl. H02K 1/22; H02K 7/10; H02K 7/08; H02K 1/12; H02K 5/20

(52) U.S. Cl. CPC H02K 1/22; H02K 1/12; H02K 5/20; H02K 7/083; H02K 7/1004

(57) ABSTRACT

A number of variations may include a product comprising a first motor or generator comprising a first stator located within a first rotor, and a first shaft operatively connected to the first rotor; a second motor comprising a second stator surrounding a second rotor, and a second shaft operatively connected to the second rotor; and wherein the second motor is nested within the first motor or generator.

### CROSS-REFERENCE TO RELATED APPLICATIONS

This application claims the benefit of U.S. Provisional Application No. 62/215,290 filed Sep. 8, 2015.

### TECHNICAL FIELD

The field to which the disclosure generally relates to includes motors/generators.

### BACKGROUND

A motor vehicle or motor driven device may require the use of dual motors.

### SUMMARY OF ILLUSTRATIVE VARIATIONS

A number of variations may include a product comprising a first motor or generator comprising a first stator located within a first rotor, and a first shaft operatively connected to the first rotor; a second motor comprising a second stator surrounding a second rotor, and a second shaft operatively connected to the second rotor; and wherein the second motor is nested within the first motor or generator.

A number of variations may include a product comprising an external rotor type motor or generator comprising a first stator located within a first rotor, and a first shaft operatively connected to the first rotor; an internal rotor type motor comprising a second stator surrounding a second rotor, and a second shaft operatively connected to the second rotor; wherein the internal rotor type motor is nested within the external rotor type motor or generator; and a housing surrounding the external rotor type motor or generator and the internal rotor type motor.

A number of variations may include a method for integrating a dual motor/generator comprising providing a first motor or generator comprising a first stator located within a first rotor, and a first shaft operatively connected to the first rotor; providing a second motor comprising a second stator surrounding a second rotor, and a second shaft operatively connected to the second rotor; and nesting the second motor within the first motor or generator.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a section view of a nested dual motor/generator according to a number of variations.

### DETAILED DESCRIPTION OF ILLUSTRATIVE VARIATIONS

The following description of the variations is merely illustrative in nature and is in no way intended to limit the scope of the invention, its application, or uses.

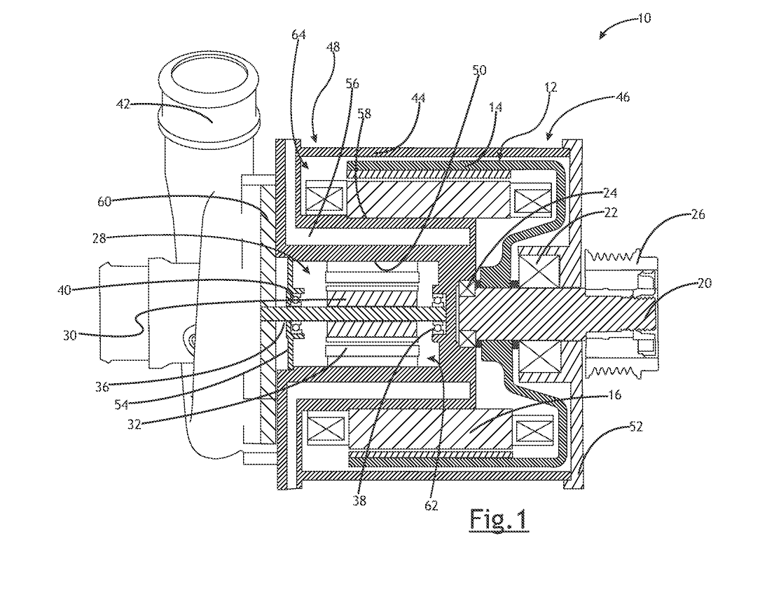

Referring to FIG. 1, in a number of variations, an integrated dual motor/generator 10 may comprise a first motor/generator 12 and a second motor 28 which may be nested within the first motor/generator 12. The first motor/generator 12 may be an external rotor type motor/generator where the rotor 14 rotates around the outside of the stator 16 and the second motor 28 may be of the internal rotor type where the rotor 30 rotates within the stator assembly 32. In one variation, the first motor/generator 12 may be a belt driven starter/generator and the second motor 28 may be an electric drive for any number of devices 42. The integrated dual motor/generator 10 may provide a compact and economic dual motor assembly. This may allow for the use of dual motors/generators in applications where space may be limited.

In a number of variations, the first motor/generator 12 and the second motor 28 may be contained within a housing 44. In a number of variations, the housing 44 may include a first side 46 and a second side 48. In a number of variations, the housing 44 may be cylindrical. In a number of variations, the second side 48 of the housing 44 may comprise a cylindrical bore defined by an inner surface 50 and an outer surface 58. In a number of variations, the inner surface 50 may form a first cylindrical cavity 62 which may be constructed and arranged to house the second motor 28 and the outer surface 58 may form a second cylindrical cavity 64 which may be constructed and arranged to house the first motor/generator 12. In a number of variations, a first cover 52 may be attached to the first side 46 of the housing 44 and a second cover 54 may be piloted and secured to the second side 48 of the housing 44. The first and second covers 52, 54 may each enclose at least a portion of the first motor/generator 12 and the second motor 28.

In a number of variations, the first motor/generator 12 may include a rotor 14, a stator assembly 16, and a shaft 20. As stated above, the first motor/generator 12 may be of an external rotor type motor/generator where the rotor 14 rotates around the outside of the stator assembly 16. The rotor 14 may be operatively attached to the shaft 20 through a press fit or spline and pilot attachment. The shaft 20 may be supported by a front bearing 22 and a rear bearing 24. In one variation, the front bearing 22 may be located within the first cover 52 and the rear bearing 24 may be located within the housing 44. An input pulley 26 may be operatively connected to the shaft 20 in any number of variations including, but not limited to, a spline attachment between the input pulley 26 and the shaft 20. In a number of variations, the first motor/generator 12 may be constructed and arranged so that there may be adequate space available inside of the first motor/generator 12 to package the second motor 28 inside of the first motor/generator 12. The first motor/generator 12 may also be constructed and arranged to include a larger diameter air gap for the radial package space and length which may provide higher power and/or torque than a conventional internal rotor type motor with the same diameter and length.

In a number of variations, the second motor 28 may include a rotor 30, a stator assembly 32, and a shaft 36. The rotor 30 may be operatively connected to the shaft 36 in any number of variations including, but not limited to, a spline attachment. The shaft 36 may be supported by a first bearing 38 and a second bearing 40. The first bearing 38 may be located within the housing 44 and the second bearing 40 may be located within the second cover 54. The shaft 36 may drive any number of devices including, but not limited to, a compressor 42, a fan, or a pump. In a number of variations, the stator assembly 32 may be installed within the inner surface 50 of the cylindrical bore in the second side 48 of the housing 44.

In a number of variations, a cooling jacket/cooling circuit 56 may be integrated within the housing 44 and may be used to cool the first motor/generator 12 and the second motor 28. In one variation, the cooling jacket 56 may be formed with the housing 44 including, but not limited to, cast with the housing 44. In a number of variations, the cooling jacket 56 may be nested between the first motor/generator 12 and the second motor 28. In one variation, the cooling jacket 56 may be integrated within the cylindrical bore between the inner surface 50 and the outer surface 58. The use of a single cooling jacket 56 shared by each of the first motor/generator 12 and the second motor 28 may significantly reduce the radial space required for the dual motors/generators.

In a number of variations, the integrated dual motor/generator 10 may also be constructed and arranged to share any number of power electronics (not illustrated). In one variation, the power electronics may be operatively attached to a plate 60 which may be adjacent the second side 48 of the housing 44.

The above integrated dual motor/generator 10 may provide a compact design using reduced costs and may provide a high power density.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a first motor or generator comprising a first stator located within a first rotor, and a first shaft operatively connected to the first rotor; a second motor comprising a second stator surrounding a second rotor, and a second shaft operatively connected to the second rotor; and wherein the second motor is nested within the first motor or generator.

Variation 2 may include a product as set forth in Variation 1 further comprising a housing, wherein the housing is constructed and arranged to accommodate the first motor or generator and the second motor.

Variation 3 may include a product as set forth in Variation 2 further comprising a cooling jacket integrated within the housing, and wherein the cooling jacket is constructed and arranged to cool the first motor or generator and the second motor.

Variation 4 may include a product as set forth in Variation 3 further comprising a first cover and a second cover, wherein the first cover is attached to a first side of the housing and the second cover is attached to a second side of the housing.

Variation 5 may include a product as set forth in any of Variations 2-4 wherein the housing is cylindrical and wherein the housing comprises a cylindrical bore defined by an inner surface and an outer surface, and wherein the inner surface forms a first cylindrical cavity constructed and arranged to house the second motor and the outer surface forms a second cylindrical cavity constructed and arranged to house the first motor or generator.

Variation 6 may include a product as set forth in Variation 5 further comprising a cooling jacket located between the inner surface and the outer surface.

Variation 7 may include a product as set forth in any of Variations 1-6 wherein the first rotor is operatively attached to the first shaft through at least one of a press fit or a spline and pilot attachment.

Variation 8 may include a product as set forth in any of Variations 1-7 wherein the first shaft is supported by a front bearing and a rear bearing, and wherein the front bearing is located within the first cover and the rear bearing is located within the housing.

Variation 9 may include a product as set forth in any of Variations 1-8 further comprising an input pulley, wherein the input pulley is operatively connected to the first shaft.

Variation 10 may include a product as set forth in Variation 9 wherein the input pulley is operatively connected to the first shaft by a spline attachment.

Variation 11 may include a product as set forth in any of Variations 1-10 wherein the first motor or generator includes an air gap having a diameter which provides for at least one of increased power or torque.

Variation 12 may include a product as set forth in any of Variations 1-11 wherein the second rotor is operatively connected to the second shaft through a spline attachment.

Variation 13 may include a product as set forth in any of Variations 4-12 wherein the second shaft is supported by a first bearing and a second bearing, and wherein the first bearing is located within the second side of the housing and the second bearing is located within the second cover.

Variation 14 may include a product as set forth in any of Variations 1-13 wherein the first motor or generator is a belt driven starter/generator and the second motor is an electric drive for an electric drive device.

Variation 15 may include a product as set forth in any of Variations 1-14 wherein the first motor or generator and the second motor are constructed and arranged to share at least one power electronic.

Variation 16 may include a product comprising: an external rotor type motor or generator comprising a first stator located within a first rotor, and a first shaft operatively connected to the first rotor; an internal rotor type motor comprising a second stator surrounding a second rotor, and a second shaft operatively connected to the second rotor; wherein the internal rotor type motor is nested within the external rotor type motor or generator; and a housing surrounding the external rotor type motor or generator and the internal rotor type motor.

Variation 17 may include a product as set forth in Variation 16 wherein the housing further comprises an integrated cooling jacket between the external rotor type motor or generator and the internal rotor type motor.

Variation 18 may include a method for integrating a dual motor/generator comprising: providing a first motor or generator comprising a first stator located within a first rotor, and a first shaft operatively connected to the first rotor; providing a second motor comprising a second stator surrounding a second rotor, and a second shaft operatively connected to the second rotor; and nesting the second motor within the first motor or generator.

Variation 19 may include a method as set forth in Variation 18 further comprising enclosing at least a portion of the first motor or generator and the second motor within a housing and at least one cover.

Variation 20 may include a method as set forth in Variation 19 further comprising integrating a cooling jacket within the housing to cool the first motor or generator and the second motor.

The above description of select variations within the scope of the invention is merely illustrative in nature and, thus, variations or variants thereof are not to be regarded as a departure from the spirit and scope of the invention.

What is claimed is:

1. A product comprising:
a first motor or generator comprising a first stator located within a first rotor, and a first shaft operatively connected to the first rotor;
a second motor comprising a second stator surrounding a second rotor, and a second shaft operatively connected to the second rotor; and
wherein the second motor is nested within the first motor or generator.

2. The product of claim 1 further comprising a housing, wherein the housing is constructed and arranged to accommodate the first motor or generator and the second motor.

3. The product of claim 2 further comprising a cooling jacket integrated within the housing, and wherein the cooling jacket is constructed and arranged to cool the first motor or generator and the second motor.

4. The product of claim 2 further comprising a first cover and a second cover, wherein the first cover is attached to a first side of the housing and the second cover is attached to a second side of the housing.

5. The product of claim 2 wherein the housing is cylindrical and wherein the housing comprises a cylindrical bore defined by an inner surface and an outer surface, wherein the inner surface forms a first cylindrical cavity constructed and arranged to house the second motor, and wherein the outer surface forms a second cylindrical cavity constructed and arranged to house the first motor or generator.

6. The product of claim 5 further comprising a cooling jacket located between the inner surface and the outer surface.

7. The product of claim 1 wherein the first rotor is operatively attached to the first shaft through at least one of a press fit or a spline and pilot attachment.

8. The product of claim 4 wherein the first shaft is supported by a front bearing and a rear bearing, and wherein the front bearing is located within the first cover and the rear bearing is located within the housing.

9. The product of claim 1 further comprising an input pulley, wherein the input pulley is operatively connected to the first shaft.

10. The product of claim 9 wherein the input pulley is operatively connected to the first shaft by a spline attachment.

11. The product of claim 1 wherein the first motor or generator includes an air gap having a diameter which provides for at least one of increased power or torque.

12. The product of claim 1 wherein the second rotor is operatively connected to the second shaft through a spline attachment.

13. The product of claim 4 wherein the second shaft is supported by a first bearing and a second bearing, and wherein the first bearing is located within the housing and the second bearing is located within the second cover.

14. The product of claim 1 wherein the first motor or generator is a belt driven starter/generator and the second motor is an electric drive for an electric drive device.

15. The product of claim 1 wherein the first motor or generator and the second motor are constructed and arranged to share at least one power electronic.

16. A product comprising:
an external rotor type motor or generator comprising a first stator located within a first rotor, and a first shaft operatively connected to the first rotor;
an internal rotor type motor comprising a second stator surrounding a second rotor, and a second shaft operatively connected to the second rotor;
wherein the internal rotor type motor is nested within the external rotor type motor or generator; and
a housing surrounding the external rotor type motor or generator and the internal rotor type motor.

17. The product of claim 16 wherein the housing further comprises an integrated cooling jacket between the external rotor type motor or generator and the internal rotor type motor.

18. A method for integrating a dual motor/generator comprising:
providing a first motor or generator comprising a first stator located within a first rotor, and a first shaft operatively connected to the first rotor;
providing a second motor comprising a second stator surrounding a second rotor, and a second shaft operatively connected to the second rotor; and
nesting the second motor within the first motor or generator.

19. A method as set forth in claim 18 further comprising enclosing at least a portion of the first motor or generator and the second motor within a housing and at least one cover.

20. The method of claim 19 further comprising integrating a cooling jacket within the housing to cool the first motor or generator and the second motor.
